(19) United States
(12) Patent Application Publication
(10) Pub. No.: US 2026/0220658 A1
(43) Pub. Date: Jul. 30, 2026

(54) Method For Estimation of the Fair Market Value of Royalties, Options on Royalties and Streaming Contracts Under Uncertainty and Imprecision

(71) Applicant: Royalty & Streaming Advisors Holdings, LLC, Portsmouth, NH (US)

(72) Inventors: John T. Rickard, Larkspur, CO (US); James G. Rickards, Portsmouth, NH (US); Thomas E. Bowens, Lynden, WI (US)

(73) Assignee: Royalty & Streaming Advisors Holdings, LLC, Portsmouth,, NH (US)

(21) Appl. No.: 18/738,478

(22) PCT Filed: Jan. 10, 2023
(86) PCT No.: PCT/US2023/010482

§ 371 Date: Jun. 10, 2024

Related U.S. Application Data
(60) Provisional application No. 63/300,000, filed on Jan. 16, 2022.
(60) Provisional application No. 63/300,391, filed on Jan. 18, 2022.
(60) Provisional application No. 63/312,116, filed on Feb. 21, 2022.

(51) Int. Cl. G06Q 30/0201

(52) U.S. Cl. CPC G06Q 30/0206

(57) ABSTRACT

Royalties and options on royalties are ubiquitous in mining, oil and gas and other commodities projects, and streaming contracts are a growing means of financing such projects, as they provide an alternative to debt or equity issuance for a company needing to raise capital to finance a commodity production project. All such instruments, along with related instruments such as offtake agreements, embody a contingent stream of payments whose fair market value (FMV) is dependent upon multiple parameters (typically dozens) involving varying degrees of uncertainty and imprecision as to their values. While it is possible in principle to estimate a scalar value of the FMV given precise knowledge of the parameters involved, the latter assumption is of course unrealistic. Current approaches to estimating the FMV of these instruments vary widely, but typically deal with the uncertain and imprecise knowledge of these parameters using spreadsheet type calculations, where numerous different choices of point values for the elements of the parameter set are selected to get a sense of the range of “nominal” values of the FMV. The high dimensionality of this type of problem, combined with the imprecise knowledge of appropriate probabilistic models for the uncertainty in each parameter, generally makes a Monte Carlo simulation approach infeasible due to the enormous number of iterations that would be required to obtain statistical significance. The methods described in this invention enable a rich alternative modeling of the uncertainties and imprecisions involved in estimating the FMV for contingent streams of payments, resulting first in an analytical distribution of FMV, which can then be analytically reduced to an interval range of values. This interval is useful as a negotiation range and its midpoint provides a nominal scalar FMV. These methods are computationally very efficient and can be applied to royalties, options on royalties, streaming contracts and other related financial instruments in mining, oil and gas, and other commodity projects, so they represent quite a general and powerful tool, different in mathematical specifics but analogous to the Black-Scholes formula for option pricing in its broad applicability.

### CROSS REFERENCE TO RELATED APPLICATIONS

This application is the US national application of PCT/US2023/010482, filed 10 Jan. 2023, which claims benefit of and priority to U.S. Provisional Patent Application No. 63/300,000, filed 16 Jan. 2022, U.S. Provisional Patent Application No. 63/300,391, filed 18 Jan. 2022, and U.S. Provisional Patent Application No. 63/312,116, filed 21 Feb. 2022, where permissible each incorporated by reference in its entirety.

### BACKGROUND

### Field of the Invention

This invention relates generally to the fields of financial instruments involving contingent streams of payments. More particularly, this invention comprises a system and method for determining streaming or royalty financing in commodity markets, including mining, oil and gas, agriculture, electricity, water or any other commodity, based on a Fair Market Value (FMV) calculation under conditions of uncertain and imprecise knowledge of the requisite input parameters. It provides an alternative financial method and implementation for purposes of transaction negotiations, proper accounting, hedging, arbitrage, and/or trading.

### 1.0 Introduction

Financial instruments involving contingent streams of payments are ubiquitous in many commodity markets, including mining, oil and gas, agriculture, electricity, water and other commodities. One of the most common such instruments is a royalty contract on a project, which entitles the royalty holder to payments based upon a specified percentage of production from the project. A royalty is frequently granted to the seller of a project as part of the deal terms, and there may be multiple royalties on any given project resulting from past transactions. Project sales involving royalties are often accompanied by a provision whereby the buyer of the project is granted an option to buy back a fraction of the royalty over some specified period into the future.

Another financial instrument of growing importance in commodities industries is a streaming contract [1], which offers a means of raising capital for a project without suffering equity dilution, particularly in cases where debt financing may not be available. This makes them particularly attractive for companies that have a “first-target” project whose production can finance the streaming obligations, while preserving more equity for the current owners in future projects. A 2021 article by the consulting firm Mckinsey & Company [2] states:

“Renewed growth sentiment among miners' management teams, combined with the rise of streaming-and-royalty financing over the past ten years, suggests that this particular type of alternative financing could be set for significant expansion over the next decade.”

Several large, publicly traded companies (e.g., Wheaton Precious Metals, Franco-Nevada, Royal Gold) are in the business of providing this type of financing.

A related type of financial instrument is the offtake agreement, the most common variety of which involves a commitment to purchase a future stream of production from a project at some specified price. This type of agreement between the buyer and seller of a commodity stream is often used as the basis for a third party to provide financing for a project, while in other cases it may be used for hedging the risk of future price changes in the commodity.

In all these instances, it is very important to have an estimate of the fair market value (FMV) of the financial instrument for purposes of transaction negotiations, proper accounting, hedging, arbitrage, and/or trading. Yet there appears to be no accepted standard approach to accounting for the inherent uncertainty and imprecision in such estimates.

Valuations are typically arrived at via intensive negotiations between parties, with little analytical foundation to account for the imprecise knowledge of the parameters that go into such estimates. For any given project, there are numerous such parameters, including the future production profile, the probabilities of future production survival, the appropriate discount factors to apply to future payments and the unknown appreciation/depreciation in the price of the underlying commodity going forward.

A major contributing factor to the contingency of the payment streams involved in these contracts is the possibility of production failure at some point during the lifetime of the stream, which would result in the loss of subsequent stream payments. Such failures can result from myriad circumstances, including accidents that cause a cessation of production, the financial failure of the producer, unforeseen regulatory or governmental actions, expropriation, changes to commodity prices or costs of labor, energy or materials/equipment that make production no longer economically feasible, etc.

Additional elements in the negotiation of the contract details are the discount factors applied to future payments (related to the perceived time-value-of-money and risk appetite of the payment recipient) and bullishness or bearishness on the future price prospects for the commodity to be delivered. Given this multiplicity of input factors, and the accompanying imprecise knowledge of these factors, it is little wonder that such contracts are highly bespoke. Indeed, the literature on them tends to be more of a descriptive nature (e.g. [1]) rather than analytical.

Human expertise is particularly valuable for estimating various attributes of a project in situations where no large database of highly comparable projects exists, which is generally the case with commodity projects given their unique physical characteristics. Subject matter experts (SMEs) in appropriate technical fields can often provide interval estimates of the parameter values for the requisite variables based upon their expert assessments, and indeed this is likely the best source of human expertise for estimating a FMV.

The interval ranges for the production profile would be specified by experts familiar with the geology, engineering or other domain-specific sciences for the project; those for the probability of production survival would also rely upon industry-specific domain expertise for the particular project. The interval ranges for the discount factors would be derived from management's assessment of the discounted present value of future payments. The interval ranges for the appreciation/depreciation would be specified from analysts' forecasts for the particular commodity. However, different SMEs will invariably provide different interval range estimates for each attribute, reflecting the inherent imprecision associated with human forecasts.

What is needed is an analytical method for FMV estimation that can incorporate multiple SME interval estimates of the fundamental parameter values involved in such calculations and can propagate the implicit imprecision and variability of these interval estimates over multiple time periods and aggregate them into a corresponding representation of an estimated range of the FMV. We provide such a method in this invention, using an ab initio derivation.

### SUMMARY OF THE INVENTION

The present invention provides an analytical method to FMV estimation that can incorporate multiple SME interval estimates of the fundamental parameter values involved in such calculations and can propagate the implicit imprecision and variability of these interval estimates over multiple time periods and aggregate them into a corresponding representation of an estimated range of the FMV.

We consider three distinct types of financial instruments, i.e., royalties, options on royalties and streaming contracts, but it will become apparent that our method can be applied to estimating the FMV of any contingent payment stream. We begin in Section 2 by deriving the scalar FMV for each of these three instruments, assuming precise knowledge of each input parameter involved. While such an assumption is unrealistic, this lays the theoretical foundation for our subsequent generalizations to account for uncertainty and imprecision in our knowledge of these parameters.

Section 3 introduces the relatively new technology of interval type-2 (IT2) fuzzy membership functions (MFs) as a representation of imprecise knowledge for a parameter. These IT2 MFs are more general than a probability distribution, as they combine both primary and secondary uncertainty in the knowledge of each parameter value. We describe a method whereby IT2 MFs can be constructed from a collection of one or more interval range estimates for each parameter provided by SMEs.

We then describe how calculations are performed using IT2 MFs. These calculations are vastly less computationally intensive than Monte Carlo simulations, and the resulting IT2 MF representation of FMV provides a full representation of the primary and secondary imprecision in this estimate. IT2 MFs can be analytically reduced to a corresponding interval range, whose midpoint provides a notional scalar value, using an operation known as type-reduction.

Section 4 generalizes the scalar FMV results derived in Section 2 by using IT2 MFs in the place of scalar values for each parameter to calculate the corresponding IT2 MF of the FMV. This output MF provides the most general representation of the uncertainty and imprecision in the FMV. The analytical type-reduction of the FMV IT2 MF to an interval range is useful for negotiations between parties to arrive at an agreed final valuation for the corresponding type of instrument. We provide examples of these computations for each type of instrument.

Section 5 describes applications of our method. It will be apparent that our method can be applied to many different financial instruments involving contingent payment streams.

### BRIEF DESCRIPTION OF THE FIGURES

FIG. 1 Illustration of an IT2 fuzzy MF for an uncertain production survival probability value P. The membership of the probability value 0.65 ranges from about 0.3 to 0.7, reflecting a lower range of membership of this particular value, whereas values around 0.63 have full membership.

FIG. 2 Illustration of α-cuts of the UMF and LMF of the IT2 MF shown. Note that each α-cut is an interval along the x-axis, corresponding to a particular value of α in the interval [0, 1].

FIG. 3 Representing an IT2 MF as a pair of arrays of the corresponding α-cuts of its UMF and LMF.

FIG. 4 IT2 MFs for (a) P₁, (b) pr₁, (c) a₁ and (d) d₁.

FIG. 5 IT2 MFs for (a) P₁₀, (b) pr₁₀, (c) a₁₀ and (d) d₁₀.

FIG. 6 IT2 MF of the FMV for a 1% royalty.

FIG. 7 IT2 MF of the FMV for a 1% royalty averaged over the LoM distribution in (26).

FIG. 8 IT2 MF of the FMV for a 0.5% royalty subject to a buyback at inception.

FIG. 9 IT2 MF of the volatility, assuming a support interval of 40% to 60%.

FIG. 10 IT2 MF of the risk-free interest rate, assuming a support interval of 2% to 3.5%.

FIG. 11 IT2 MF of the FMV of the premium for a 0.5% royalty buyback option.

FIG. 12 IT2 MF of the FMV of the premium for a 0.5% royalty buyback option, assuming immediate exercise and the LoM distribution in (26).

FIG. 13 IT2 MF of the FMV for a 0.5% royalty subject to a buyback at year 5, exercised at the beginning of year 5.

FIG. 14 IT2 MF of the FMV of the premium for a 0.5% royalty buyback option exercised at the beginning of year 5.

FIG. 15 IT2 MF of the FMV of the UFP for a stream in years 2-13 with no discounted payment per unit.

FIG. 16 IT2 MF of the FMV of the UFP for a stream in years 2-13 with no discounted payment per unit, averaged over the LoM.

### DETAILED DESCRIPTION OF INVENTION

### 2.0 Scalar Derivation of FMV for Contingent Payment Streams

We begin by deriving a scalar estimate of the FMV for a contingent payment stream, under the (unrealistic) assumption that all the parameters associated with the estimate are known precisely, i.e., as scalar values. Since this case corresponds to the payment stream associated with a royalty, we first address this type of instrument.

### 2.1 Input Parameters

The inputs to a royalty FMV evaluation are the royalty percentage r, the current price of the commodity ps per unit on which the royalty is based (e.g., the net smelter return (NSR) price in the mining industry), the production quantities prᵢ over future production periods, the a priori probabilities Pᵢ of production survival to the end of the i^{th} period, the appreciation/depreciation factors aᵢ assumed for the subject commodity, and the future payment discount factors dᵢ, for all periods i=n0, . . . , n, where n is the number of periods of the royalty payments (which may be fixed or variable) and n0 is the period subsequent to the present in which royalty payments are projected to begin (i.e., for projects not yet in production).

The Pᵢ, aᵢ and dᵢ values can be arbitrarily specified subject to their natural constraints (e.g., 0≤Pᵢ≤1), with the only additional constraints being that Pᵢ₋₁≥Pᵢ for all i, since successive production survival probabilities cannot increase with time. One means of generating the Pᵢ values is through the use of hazard rates λᵢ, where (1−λᵢ) Pᵢ₋₁ is the probability of production survival in period i, given the probability of production survival P to the period i−1. Thus, we have by iteration,

$${P}_{i} = ( 1 - {λ}_{1} ) ( 1 - {λ}_{2} ) … ( 1 - {λ}_{i} ) , \qquad ( 1 )$$

where, by definition, P₀=1.

### 2.2 Scalar FMV of a Royalty

The a priori FMV of a contingent stream of payments such as those associated with a royalty, where the payments have a non-zero probability of halting due to production failure, is composed of the difference between two components: 1) the expected value of the discounted present value (DPV) of all future payments with respect to the production survival probabilities, which we denote by E[DPV], and 2) the a priori expected accrual value of discounted halted royalty payments, which we denote by E[DPVh]. The latter term assumes that no royalty payment is made in a period when production halts. Note that we cannot know a priori whether production will continue to the end of all periods or whether it will halt in some period; hence the difference between these two terms is our best a priori unconditional estimate of FMV to account for all possibilities.

The appreciated/depreciated discounted value of a future royalty payment at the end of the i^{th} period, during which pr units of the commodity is produced, is ps(r/100)aᵢdᵢprᵢ, and the a priori unconditional probabilities of halted payments during period i is given by (Pᵢ₋₁−Pᵢ), where P₀=1. Thus, we have:

$$E [ D P V ] = p s ( \frac{r}{100} ) {\sum }_{i = n 0}^{n} {P}_{i} {pr}_{i} {a}_{i} {d}_{i} , \qquad ( 2 )$$

$$and$$

$$E [ DPVh ] = \frac{1}{2} p s ( \frac{r}{100} ) {\sum }_{i = n 0}^{n} ( {P}_{i - 1} - {P}_{i} ) {pr}_{i} {a}_{i} {d}_{i} , \qquad ( 3 )$$

where the ½ factor in (3) arises as a result of uniformly averaging halted payments over each time period.

The a priori FMV of the royalty payments is E[DPV] less E[DPVhalt], i.e.,

$$FMV = ps ( \frac{r}{100} ) [ {\sum }_{i = n 0}^{n} {P}_{i} {pr}_{i} {a}_{i} {d}_{i} - \frac{1}{2} {\sum }_{i = n 0}^{n} ( {P}_{i - 1} - {P}_{i} ) {pr}_{i} {a}_{i} {d}_{i} ] . \qquad ( 4 )$$

To use some illustrative values, suppose we assume a 1% royalty, a constant annual hazard rate of λᵢ=0.06 for all i (i.e., a 6% production failure probability in each successive year, given that production survived to the previous year), a current commodity price ps of $1,800 per unit, a net appreciation/depreciation factor of unity in all years (i.e., no change with respect to the current commodity price), an annual discount rate of r=12% and a royalty duration of n=9 years, with royalty payments starting at the end of the first period, i.e., n0=1 for a producing project.

The P vector values for i=0, . . . , 9 (with P₀=1) and the a and d vector values for periods i=1, . . . , 9 corresponding to these assumptions are:

$$P = {[ \begin{matrix}1 & 0.94 & 0.884 & 0.831 & 0.781 & 0.734 & 0.69 & 0.648 & 0.61 & 0.573\end{matrix} ]}^{T} \qquad ( 5 )$$

$$a = {[ \begin{matrix}1 & 1 & 1 & 1 & 1 & 1 & 1 & 1 & 1\end{matrix} ]}^{T} \qquad ( 6 )$$

$$d = {[ \begin{matrix}0.88 & 0.774 & 0.681 & 0.6 & 0.528 & 0.464 & 0.409 & 0.36 & 0.316\end{matrix} ]}^{T} . \qquad ( 7 )$$

We further assume a variable production profile for periods i=1, . . . , 9, where the units produced per period is given by:

$$( 8 )$$

$$pr = {[ \begin{matrix}37088 & 28842 & 13680 & 27360 & 27360 & 27720 & 28800 & 28800 & 28800\end{matrix} ]}^{T}$$

With these values and using (2)-(4), we have E[DPV]=$1,973,057 and E[DPVh]=$62,970, and thus the fair market value of the royalty is the difference between these two numbers, or $1,910,087.

We note at this point that the expressions in (1)-(4) are discrete-time approximations to what are actually continuous-time variables. Designating the relevant variables in continuous time as P(t), pr(t), a(t) and d(t), respectively, the corresponding continuous-time versions of (2)-(3) are:

$$E [ DPV ] = p s ( \frac{r}{100} ) {\int }_{0}^{T} P ( t ) p r ( t ) a ( t ) d ( t ) dt \qquad ( 9 )$$

$$E [ DPVh ] = ps ( \frac{r}{100} ) [ {\int }_{0}^{T} [ P ( t ) - P ( t + τ ) ] p r ( t ) a ( t ) d ( t ) dt ] \qquad ( 10 )$$

where T is the total production period, t is the payment interval and P(t)=P(T) for all t≥T. Note that we have removed the factor ½ in (10) since the integral now incorporates the averaging of halted payments. Thus, the FMV on a continuous-time basis is the difference between (9) and (10), which simplifies to:

$$FMV = ps ( \frac{r}{100} ) [ {\int }_{0}^{T} P ( t + τ ) p r ( t ) a ( t ) d ( t ) dt ] \qquad ( 11 )$$

Note that in the limit as τ→0, FMV→E[DPV] in (9), which is simply the a priori unconditional expected discounted present value of the full payment stream. This case corresponds to the (unrealistic) situation of continuous royalty payments being made in real time, where there is no accounting required for the a priori accrual value of halted payments due to the vanishingly small payment interval.

### 2.3 Accommodating Uncertainty in the Production Period

To account for uncertainty in the production period for which royalty payments are made (e.g., the life of mine (LoM) in the mining industry or the life of a well in the oil and gas industry), we can define a discrete probability distribution for this variable, and then average the FMV of the royalty payments ending in each period over this distribution.

For example, suppose the production period probability distribution over periods i=1, . . . , 9 of a particular mining project is given by

$${P}_{L o M} = {[ \begin{matrix}0 & 0 & 0 & 0 & 0 & 0 & 0.2 & 0.4 & 0.4\end{matrix} ]}^{t} \qquad ( 12 )$$

such that the LoM is projected to be between 7 and 9 periods, as shown. Then the FMV is given by

$$\overline{E} [ FMV ] = {\sum }_{k = 1}^{n} {P}_{L o M} ( k ) FMV ( k ) , \qquad ( 13 )$$

where FMV(k) is the FMV of royalty payments lasting k periods, and the bar over Ē[FMV] represents the average over the discrete LoM probability distribution.

In the case where P_{LoM} is given by (12), this results in a fair market value in the previous royalty example equal to Ē[FMV]=$1,833,479, as compared to $1,910,087 in the case of a fixed 9-period LoM. The relatively small difference between these values is because the non-zero probabilities of the LoM distribution fall well into the future, where the royalty payments are heavily discounted.

### 2.4 Scalar FMV of an Option on a Royalty

A frequent part of the terms in any transaction involving natural resource projects is for the seller of a project to retain a royalty on future production and for the buyer to have an option over some specified period to purchase a portion of this royalty back from the seller. A typical example might be for the seller to retain a 1% royalty on production from the property, with the buyer having the option to buy back one-half of this royalty (i.e., 0.5%) over a period of say 5 years, for some specified price. This provision is denoted as a “royalty buyback option” in the contract between the buyer and seller.

It is often the case that both the royalty and the buyback option terms in such contracts are specified with little or no detailed analysis of the estimated value for either provision. In other words, they are often considered merely as “deal sweeteners” for both the seller and the buyer, respectively.

Often, the royalty itself is ascribed a “notional value” by simply dividing the buyback option strike price by the fraction of the royalty subject to this option. So, for example, in the above instance, if the buyer agrees to a buyback strike price of $2 million to purchase one-half of the 1% royalty from the seller within the option period, then the notional value of the royalty is simply taken as $4 million. Frequently, different royalties may apply to different minerals extracted from a project and/or to different sets of claims comprising an overall project, with each one having different buyback terms.

There are multiple problems associated with this perspective on buyback provisions. In the first place, the buyback provision is in fact a call option on an asset (in this case, a fraction of the royalty), in conjunction with a specified strike price (i.e., the “buyback price”).

Second, as with any option, there exists a premium that should be related to the value of the royalty; however, this premium is not equal to the strike price of the option but is often comingled with the latter. In fact, the premium on a buyback option is often ignored and as a result is effectively assigned a zero value. Should the option later be sold or transferred, the premium value will have declined due to the shorter time to expiration, all other values remaining the same.

A third problem is that projects generally have a finite production period, which may not be substantially longer than the expiration period on the option. In such cases, if the buyback option exercise is delayed until near expiration, its value may change quite significantly since the repurchased royalty stream resulting from the option exercise will have a shorter duration, and thus will correspond to a reduced overall royalty income stream.

In this section, we present a scalar estimate of the FMV of an option on a royalty, i.e., assuming all parameters involved in the option are known precisely. We employ the well-known Black-Scholes model for evaluating a European-style option (i.e., one that can be exercised only upon its expiration, but whose premium values are similar to American-style options, which can be exercised at any time up to expiration).

The Black-Scholes model is based upon the century-old diffusion equation (also known as the Fokker-Planck-Kolmogorov equation), a well-known partial differential equation in physics [5] originally developed to describe the time evolution of the probability density function (pdf) of the position of a particle subject to Brownian motion.

This model was adapted to the financial markets in 1973 by Fischer Black and Myron Scholes (and independently by Robert Merton) by their recognition that the logarithm of the ratio of successive prices (i.e., the fractional price returns) in financial instruments could be modeled as a random process driven by continuous Brownian motion in the limit as the time interval vanishes. Combined with additional idealized market assumptions, these authors were able to develop an analogous partial differential equation describing the evolution of the fair market value (i.e., the premium) of a call or put option over time and find a solution to this equation [6].

This solution is the celebrated Black-Scholes formula, which for the premium of a call option is given by:

$$c ( {S}_{t} , T , K , σ , r , t ) = N ( {d}_{1} ) {S}_{t} - N ( {d}_{2} ) K {e}^{- r ( T - t )} , \qquad ( 14 )$$

Where N(●) is the standard normal cumulative distribution function, Sᵢ is the current price at time t of the underlying security on which the option is based, T≥t is the future time at which the option expires, K is the strike price (i.e., the price at which the option can be exercised), σ is the standard deviation of the log price returns of the underlying security (commonly denoted as “volatility”) and r is the risk-free interest rate at current time t. The arguments of the N(●) functions in (14) are given by:

$${d}_{1} = \frac{1}{σ \sqrt{T - t}} [ ln ( \frac{{S}_{t}}{K} ) + ( r + \frac{{σ}^{2}}{2} ) ( T - t ) ] \qquad ( 15 )$$

$${d}_{2} = {d}_{1} - σ \sqrt{T - t} .$$

The Black-Scholes formula and certain of its variations are used ubiquitously in financial applications to value option premium prices. Notwithstanding the fact that some of its assumptions are idealized, it remains the gold standard for the valuation of options in financial markets, accounting, etc. Its ease of numerical evaluation almost immediately spawned a revolution in options trading, leading to the formation of options exchanges worldwide and to the widespread use of options in hedging risk and in speculation. Black-Scholes also became the foundation of the $1 quadrillion over-the-counter derivatives markets, which can be evaluated as strips of options. Our method also works well with various extensions of the Black-Scholes formula [7] including the binomial pricing model, models of interest rate changes that are path dependent, skewness, and different boundary conditions, but here we focus on the original Black-Scholes formula due to its ubiquitous use in the financial community.

Upon examination of the parameters that go into the Black-Scholes formula, the only one for which going-forward assumptions typically must be made in conventional applications is the appropriate value of the volatility σ in the price of the underlying security, since all others are either known precisely (i.e., the strike price and the time to expiration) or are assumed to be readily available from market data (i.e., the current underlying security price and the risk-free interest rate r). Normally, the value of σ is estimated from the historical volatility of the security.

However, when the underlying security is a royalty, i.e., the entitlement to a contingent payment stream, we have already shown in Section 2.2 that the value of the royalty is a complex function, involving more than just the price of the underlying commodity itself. Thus, the volatility of the royalty will not correspond precisely to the volatility of the underlying commodity, and the value of σ used in the Black-Scholes model for calculating the value of a buyback option will generally differ from the historical average volatility of the underlying commodity price.

Using the example in Section 2.2 of a 1% royalty with a 9-year term having a scalar FMV of $1,910,087, let us assume using the traditional approach that the grantor of this royalty has a buyback option on ½ of the royalty for a period of 5 years, at a strike price equal to ½ of the scalar FMV at inception, or $955,044. Thus, the current “market” price of the underlying 0.5% royalty subject to the buyback option has this same value of $955,044. We further assume for illustration an annual volatility of 30% in the royalty value, which is in the typical range. In this case, the Black-Scholes model yields a premium value for the buyback option of $305,501.

This scalar example illustrates the often-neglected value of a buyback option premium. Note that the option premium itself has a value of nearly ⅓ of its strike price at the time that it is granted. Yet this value is frequently ignored in negotiations between the parties to a transaction in which a royalty and buyback option are included. Note further that the value of the buyback option premium declines with time, going to zero at its expiration in 5 years. Furthermore, the value of the royalty itself also declines with time due to its finite duration, which suggests that the best strategy for the holder of the buyback option often may be either to exercise it promptly or to sell it to another party.

### 2.5 Scalar FMV of a Streaming Contract

Streaming contracts tend to be highly bespoke and typically result from intensive negotiations between the company and the stream purchaser. In some cases, the stream purchaser agrees to pay a discounted price for the stream commodity, while in others, no such payment is required. The stream payments may have a defined lifetime, but in other cases, they may persist over a variable period. The specific upfront payment (UFP) for the contract per unit of the commodity to be received is the key negotiated value in the contract.

In this section, we derive a fair market value (FMV) for the UFP per unit of a streaming contract, under the (unrealistic) assumption that all input parameters are known precisely, using the same input parameter notations as in Section 2.1, with the additional parameter being the purchase price δ in dollars per unit paid by the stream recipient (which may be 0).

Analogous to (2) and (3), the appreciated/depreciated discounted value of a future payment, accounting for δ, is (pₛₚₒₜaᵢ−δ)dᵢ, and the a priori probabilities of halted payments in period i is given by (Pᵢ₋₁−Pᵢ). Thus, we have:

$$E [ DPV ] = {\sum }_{i = n 0}^{n} {P}_{i} ( {p}_{s p o t} {a}_{i} - δ ) {d}_{i} , \qquad ( 16 )$$

$$E [ DPVhalt ] = \frac{1}{2} {\sum }_{i = n 0}^{n} ( {P}_{i - 1} - {P}_{i} ) ( {p}_{s p o t} {a}_{i} - δ ) {d}_{i} , \qquad ( 17 )$$

where, again, the factor ½ arises from uniform averaging of halted payments over each period since some stream payments generally will be due even during a period where production halts by the end of that period.

The a priori FMV of the stream payments is E[DPV] less E[DPVhalt], i.e.,

$$FMV = {\sum }_{i = n 0}^{n} {P}_{i} ( {p}_{spot} {a}_{i} - δ ) {d}_{i} - \frac{1}{2} {\sum }_{i = n 0}^{n} ( {P}_{i - 1} - {P}_{i} ) ( {p}_{spot} {a}_{i} - δ ) {d}_{i} \qquad ( 18 )$$

Note that a similar form of (18) can be used in most common offtake agreements, wherein the buyer and seller of the commodity agree to transact a specified amount at specified prices in each period over a specified total number of periods. The agreed price may vary with time, so in place of a single value of δ in (18), we may use δᵢ in each term of this equation, and if the amount to be delivered varies, we would incorporate a quantity term and consider the FMV for the total rather than per unit.

The buyer and seller in such an offtake agreement will generally have their own perspectives on the remaining variables in this equation, but in the unlikely case that they were to agree on identical hazard rates, discount rates and appreciation/depreciation factors, the nominal FMV of the offtake agreement should be zero, since the buyer would be paying exactly what the seller expected to receive. A negative FMV estimate by the seller would be considered favorable to them, as it would suggest the buyer is overpaying for the stream relative to the seller's anticipated future market prices, whereas a positive FMV estimate by the buyer would suggest the seller is delivering the stream at lower unit costs than the buyer's anticipated future market prices. Given the similarity of the analysis between streaming agreements and offtake agreements, we focus on the former in what follows.

To use some illustrative values for streams, suppose as in (5)-(7) we assume a constant annual hazard rate of λᵢ=0.06 for all i (i.e., a 6% failure probability in each year, given that production survived to the previous year), a net appreciation/depreciation factor of unity in all years (i.e., no change with respect to the current spot price), an annual discount rate of r=12% demanded by the stream purchaser, a value of δ=0 (i.e., no payments required for stream deliveries), a spot price of pₛₚₒₜ=$1,800 dollars and a defined stream duration of n=13 years, with payments starting in year n0=2.

The corresponding P, a and d vector values through year 13 are:

$$P = {[ \begin{matrix}0.94 & 0.884 & 0.831 & 0.781 & 0.734 & 0.69 & 0.648 & 0.61 & 0.573 & 0.539 & 0.506 & 0.476 & 0.447\end{matrix} ]}^{T}$$

$$a = {[ \begin{matrix}1 & 1 & 1 & 1 & 1 & 1 & 1 & 1 & 1 & 1 & 1 & 1 & 1\end{matrix} ]}^{T}$$

$$d = {[ \begin{matrix}0.88 & 0.774 & 0.68 & 0.6 & 0.528 & 0.464 & 0.409 & 0.36 & 0.316 & 0.279 & 0.245 & 0.216 & 0.19\end{matrix} ]}^{T}$$

With these values and using (16)-(18), we obtain E[DPV]=$6,396 and E[DPVhalt]=$204 and thus the FMV of the UFP per unit of the commodity delivered each year is $6,192. So, under these assumptions, a stream purchaser would pay $6,192 in UFP to receive 12 one-unit payments per year, starting in year 2 and going through year 13. The present value, if all payments were received up front, would be 12×$1,800=$21,600, but of course the heavy discount rate of 12% annually substantially diminishes the value of the payments made over time.

### 2.6 Adding Uncertainty as to the Duration of Stream Payments

As was done in Section 2.2 for royalties, we can account for uncertainty in the duration of the stream payments by defining a discrete probability distribution for this variable, and then averaging the FMV of the stream over this distribution. Suppose in the case of a mining project this probability distribution over years is given by

$${P}_{LoM} = {[ \begin{matrix}0 & 0 & 0 & 0 & 0 & 0 & 0 & 0 & 0 & 0 & 0.5 & 0.4 & 0.1\end{matrix} ]}^{T} \qquad ( 19 )$$

such that the LoM is projected to be 11-13 years, with declining probabilities beyond year 11, as shown. Then the FMV is given by

$$\overline{E} [ FMV ] = {\sum }_{k = 0}^{n} {P}_{L o M} ( k ) FMV ( k ) , \qquad ( 20 )$$

where FMV(k) is the FMV of a stream lasting k years, and the bar over Ē[FMV] represents the average over LoM.

In the case where P_{LoM} is given by (19), this results in a FMV of the UFP of Ē[FMV]=$5,969 per unit, as compared to a $6,192 UFP for a 13-year defined stream. The relatively small difference is due to the non-zero probabilities of the LoM distribution falling well into the future, where the stream payments are heavily discounted.

### 2.7 Certainty Equivalent Cash Discount Rate

Before moving to the imprecise cases, we mention that the “certainty equivalent discount rate” is often used to measure the perceived risk of an investment. From Kenton [8],
“The certainty equivalent is a guaranteed return that someone would accept now, rather than taking a chance on a higher, but uncertain, return in the future. Put another way, the certainty equivalent is the guaranteed amount of cash that a person would consider as having the same amount of desirability as a risky asset.”

Further quoting from Kenton [8], “The certainty equivalent cash flow is the risk-free cash flow that an investor or manager considers equal to a different expected cash flow which is higher, but also riskier. The formula for calculating the certainty equivalent cash flow is as follows:

$$Certainty equivalent cash flow = \frac{Expected cash flow}{( 1 + risk premium )} \qquad ( 21 )$$

where the risk premium represents the risk-adjusted rate of return minus the risk-free rate. The expected cash flow is calculated by taking the probability-weighted dollar value of each expected cash flow and adding them up.”

Rearranging (21), we have:

$$risk premium = ( \frac{Expected cash flow}{Certainty equiv . cash flow} - 1 ) * 100. \qquad ( 22 )$$

Since the FMV cash flow theoretically represents the risk-compensated cash flow that an investor should accept for a streaming contract and E[DPV] represents the expected discounted cash flow from the stream, we can use (16) and (18) in (22) to calculate the certainty equivalent risk premium as

$$risk premium = ( \frac{E [ DPV ]}{FMV} - 1 ) * 100. \qquad ( 23 )$$

For the above case of scalar input values (not including the LoM averaging), the risk premium value is calculated as 3.297%, which is the surplus over the return of 12% demanded by the stream purchaser.

As a final note, one can calculate the number of units of the stream payment required to raise a given total of upfront payments as

$$stream payments = \frac{Total upfront payments}{\overline{E} [ FMV ]} , \qquad ( 24 )$$

where in this case we use the LoM averaged FMV. Using the above illustrative case values, each $10 million of upfront payments would thus require 1,675 units of the commodity to be delivered each year over the LoM.

### 3. Generalizations to Account for Uncertainties and Imprecision

In the real world, knowledge of all the future parameters used in calculating the FMV for a contingent stream of payments is always imprecise. Traditionally, this lack of precision is characterized as “random uncertainty” and is typically addressed using Monte Carlo simulations, where assumptions are made about imprecisely known probability distributions for each input parameter and pseudo-random draws are made over a range of these distributions to obtain a particular realization of a streaming outcome. The outcomes of these realizations are then averaged to determine an estimate of the FMV.

Many millions of such realizations must be generated to obtain a statistically valid estimate of the output probability distribution of the FMV calculation, from whence we can compute an average value with its corresponding uncertainty (e.g., standard deviation). Furthermore, the required number of realizations in the simulation increases exponentially with the number of input parameters due to the so-called “curse of dimensionality,” since we must generate enough multivariate realizations to account for the imprecisely known statistical variability of each dimension. And of course, the results of the simulation depend critically upon the legitimacy of the assumed probability distributions for each parameter. A change in any one of these distributions requires a repeat of the Monte Carlo simulation.

### 3.1 Modeling Uncertainty and Imprecision Using Fuzzy Membership Functions

Fortunately, there is a much better way to analyze such problems, using fuzzy MF representations of the input parameters, followed by a corresponding calculation of the fuzzy MF of the FMV. By using interval type-2 (IT2) MFs [3] [4] to represent all parameters, we can account not only for the primary distribution of the imprecision in our knowledge of each parameter, analogous to the probability distribution assumptions required in a Monte Carlo analysis, but also for our imprecise knowledge of these primary distributions.

This is analogous to employing secondary probability distributions for modeling the uncertain knowledge of the “primary” probability distribution parameters in a Monte Carlo simulation, which of course compounds the complexity of the simulation to a degree making it computationally infeasible.

In contrast, the FMV calculations using the IT2 method can be carried out on a laptop computer in a few seconds or less. To those unfamiliar with IT2 fuzzy representations, we will use figures to illustrate this method, after which it will become obvious what these representations describe. We will also use figures to describe the way calculations are performed using these IT2 MFs in Section 3.2

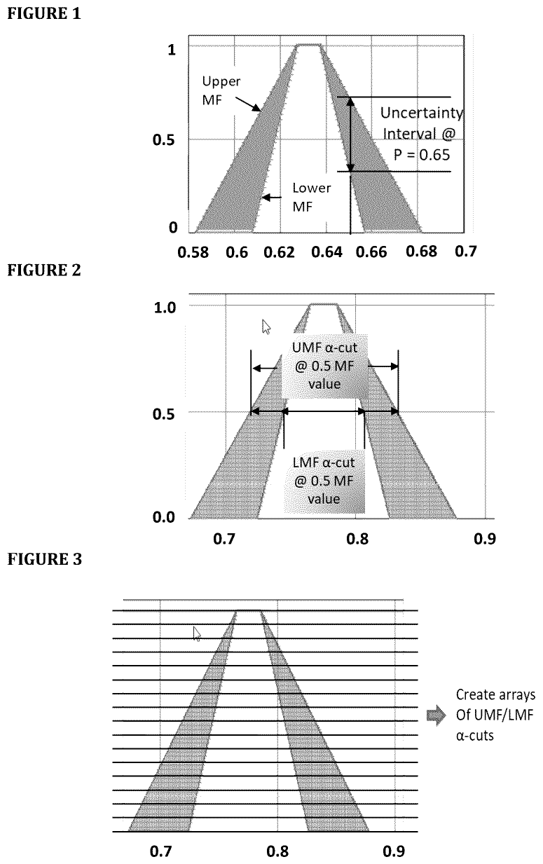

FIG. 1 illustrates an IT2 fuzzy MF, with its associated upper MF (UMF) and lower MF (LMF), i.e., the upper and lower bounding curves. The interpretation of an IT2 MF is as follows: the horizontal extent shows the range of the corresponding UMF and LMF functions, and the corresponding “footprint of uncertainty” (FOU) is the shaded area between these curves.

If we take a vertical slice through the IT2 MF at any particular value x on the horizontal axis, the range of values (between 0 and 1) over which this slice intersects the FOU indicates the interval range of secondary imprecision in our knowledge of the corresponding parameter. (This would be analogous to having uncertain knowledge about a parameter in a probability distribution.)

As in the case of probability distributions used in Monte Carlo simulations, assumptions must be made regarding the forms of these IT2 MFs. However, the very nature of these MFs allows us naturally to represent the compound imprecision (primary and secondary) in our knowledge of these parameters, and to perform calculations rapidly in response to changes in these assumptions.

Given that there are innumerable possible variations in these MFs, we first present a simple and straightforward method for the generation of trapezoidal IT2 MFs for our applications, such as that shown in FIG. 1.

In real-world cases, these IT2 MFs can be calculated from sets of interval ranges supplied by one or more SMEs for each parameter using for example the methods described in [9] or using proprietary methods, but for purposes of illustration we shall employ the simpler construction method described below. It will be apparent that numerous variations on these construction methods can be implemented without limiting the scope of this invention. Furthermore, higher-order fuzzy membership representations, e.g., general type-2 membership functions, may be used to represent the parameters of our model, along with analogous computational techniques to those described below, without limiting the scope of this invention.

Referring to (4), there are four groups of parameters whose future values are imprecisely known for a contingent payment stream: prᵢ, Pᵢ, aᵢ and dᵢ, for i=1, . . . , n. Thus, for example, in the case of a 13-year duration of a stream of payments, there are 52 such parameters. For each of these parameters, we model its imprecisely known value using an IT2 fuzzy MF, using the illustrative construction described below. (In real-world applications, these MFs would be synthesized from interval data provided by SMEs.)

We first specify the support intervals of the UMF for each value of prᵢ, Pᵢ, aᵢ and dᵢ, for i=1, . . . , n, i.e., the intervals over which their corresponding UMFs have non-zero values. In the case of the survival probabilities, we can specify interval ranges directly or use interval ranges on the annual hazard rates and employ (1) to generate the corresponding interval support ranges of the UMFs for the elements of P. These UMF support intervals bound the extreme ranges of values for each parameter.

Next, we specify the fraction of these support intervals over which the fuzzy MF values are unity for both the UMF and the LMF. This smaller interval can be viewed as the range of values considered most representative of the corresponding parameter. Finally, we specify the fraction of the UMF support intervals representing the support intervals for their corresponding LMFs. In the following, we use values of 10% and 70%, respectively, for these percentages. These rules are of course an arbitrary means of generating the corresponding

MFs, but they provide illustrative MFs for illustrating our method. To emphasize, our method can accommodate arbitrarily constructed MFs for all quantities and can perform the prescribed calculations in seconds for a given case.

3.2 Calculating with IT2 Membership Functions

Calculations involving IT2 MFs are performed using “α-cuts” [3] [4] of the associated upper and lower MFs. An α-cut is the interval corresponding to a horizontal slice of the UMF (or LMF) at a particular value of membership a in the interval [0, 1]. FIG. 2 illustrates an α-cut of the UMF and LMF of an IT2 MF at an a value of 0.5 membership.

If we calculate arrays of the UMF and LMF α-cuts of an IT2 MF at sufficiently small increments of a ranging from 0 to 1, the resulting pair of arrays is a good representation of the overall MF. FIG. 3 notionally illustrates this process of calculating α-cut slices. In practice, we typically use a increments of 0.01 to compute these α-cuts, resulting in 101 α-cuts in the interval [0, 1], including both endpoints.

The union of all the UMF and LMF α-cuts of an IT2 MF provides an approximate representation of the entire MF, with the approximation becoming more exact as the number of α-cuts increases.

Once the α-cut arrays are computed for each IT2 MF of the parameters involved in a formula such as (4), we use the interval endpoints of corresponding α-cuts, in conjunction with interval arithmetic, to calculate the minimum and maximum values of the corresponding α-cuts of the FMV IT2 MF. This same general method can be used for any mathematical formula involving only arithmetic operations.

For more complex formulas, these minimum and maximum values of each α-cut may be calculated using standard nonlinear optimization algorithms available in most mathematical programming libraries. These algorithms provide extremely fast numerical evaluations of maxima and minima over the corresponding α-cut interval bounds.

The final step is to assemble the arrays of the α-cuts for the resultant IT2 MF into an α-cut representation of this MF. The analytical “type-reduction” of this IT2 MF into a best interval representation is performed using the “Karnik-Mendel algorithm” as described in [3] [4]. The resulting interval is analogous to an “error range” for the subject IT2 MF. The center of the interval provides the nominal scalar representation of the IT2 MF.

### 4. Example Calculations

With these preliminaries, and to illustrate our method, let us assume the ranges shown in (25) for the input parameters for a gold project, starting with year 1 (the end of the current year) and going through year 10, where the variable hazard rate intervals λᵢ are used to generate the corresponding survival probability intervals Pᵢ and the production intervals pr are in thousands of ounces. Using these interval ranges in conjunction with the UMF and LMF generation method described above, we now present some of the resulting IT2 MFs, first for a royalty evaluation.

$$pr = [ \begin{matrix}80 & 100 \\ 100 & 120 \\ 130 & 150 \\ 150 & 170 \\ 150 & 170 \\ 130 & 150 \\ 120 & 140 \\ 90 & 110 \\ 70 & 90 \\ 40 & 60\end{matrix} ] λ = [ \begin{matrix}0 & 0 \\ 0.06 & 0.08 \\ 0.05 & 0.07 \\ 0.05 & 006 \\ 0.04 & 0.05 \\ 0.03 & 0.04 \\ 0.03 & 0.04 \\ 0.02 & 0.03 \\ 0.01 & 0.02 \\ 0.01 & 0.02\end{matrix} ] , P = [ \begin{matrix}0.92 & 0.94 \\ 0.856 & 0.893 \\ 0.804 & 0.848 \\ 0.764 & 0814 \\ 0.733 & 0.79 \\ 0.704 & 0766 \\ 0.683 & 0 \text{.751} \\ 0.663 & 0736 \\ 0.649 & 0729 \\ 0.636 & 0 \text{.721}\end{matrix} ] \qquad ( 25 )$$

$$a = [ \begin{matrix}0.99 & 0.107 \\ 0.98 & 1.145 \\ 0.97 & 1.225 \\ 0 \text{.961} & 1.311 \\ 0 \text{.951} & 1.403 \\ 0 \text{.941} & 1.501 \\ 0.932 & 1.606 \\ 0.923 & 1.718 \\ 0.914 & 1.838 \\ 0.904 & 1.967\end{matrix} ] , d = [ \begin{matrix}0.94 & 0.98 \\ 0.884 & 0.96 \\ 0 \text{.831} & 0 \text{.941} \\ 0781 & 0.922 \\ 0.734 & 0.904 \\ 0.69 & 0.886 \\ 0.648 & 0.868 \\ 0.61 & 0 \text{.851} \\ 0.573 & 0.834 \\ 0.539 & 0.817\end{matrix} ] .$$

### 4.1 Example Calculations for Royalties

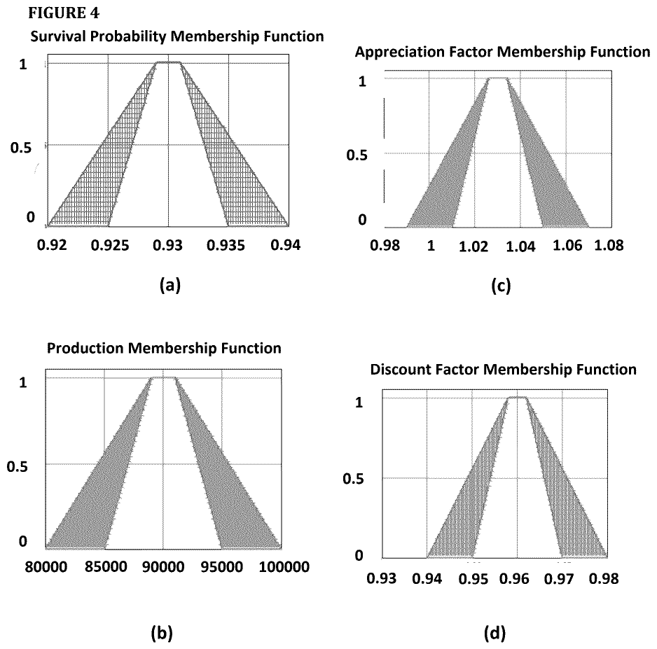

FIGS. 4(a)-(d) show the year-1 IT2 MFs for P₁, a₁ and d₁ as constructed using the first rows of the arrays in (25) using the method described above. Thus for example in FIG. 4(a), if we select the value x=0.93, the range of secondary imprecision is the collapsed interval [1, 1], indicating this value of x is highly representative for P₁, whereas if we take x=0.925, the corresponding vertical slice interval is roughly [0, 0.55], indicating that the value x=0.925 has both lower degrees of confidence in being a representative value for P₁ and greater imprecision in assessing this degree of confidence, due to the large range of secondary values.

Overall, there is an interval range of values of x centered around x=0.93 in FIG. 4(a), for which we have highly representative values for P₁, and a much larger range of values of x in which we have lesser (and varying) degrees of confidence for being a valid value for P₁.

Similar comments apply to the IT2 MFs for the production pr₁, appreciation/depreciation factor a₁ and the discount factor d₁ in year 1.

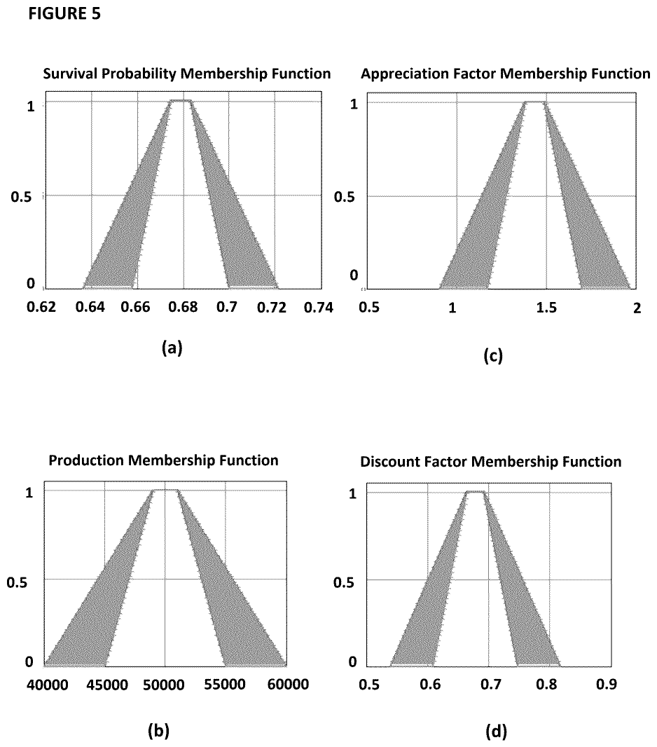

Going to the final year 10, the corresponding MFs for P₁₀, pr₁₀, a₁₀ and d₁₀ are shown in FIGS. 5(a)-(d), using our illustrative construction method on the final rows of the arrays in (25). As expected, the support interval of the UMF for P₁₀, has declined to a range of about [0.635, 0.72], the support interval of the UMF for a₁₀ has expanded to a range of about [0.9, 1.9] and the support interval of the UMF for d₁₀ has declined to about [0.55, 0.82], reflecting lower values for survival probability, greater imprecision in the cumulative appreciation/depreciation and higher values of the discount factor, respectively.

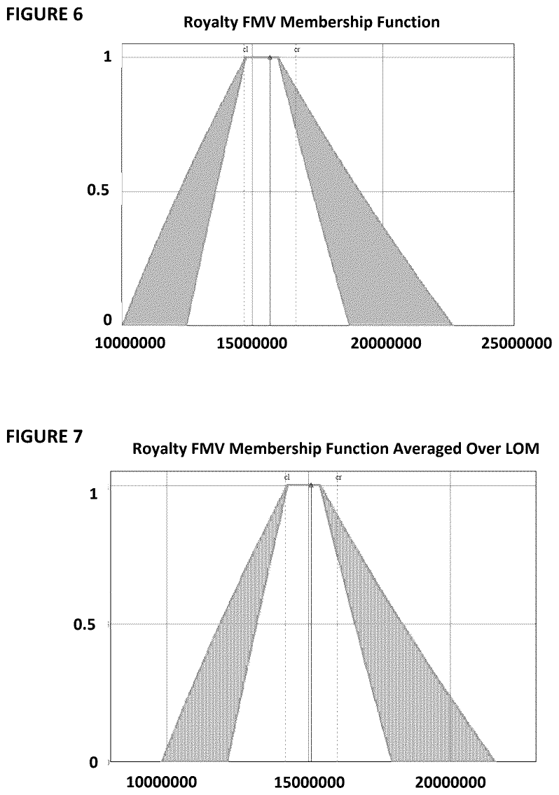

Now assume the current net smelter return gold price is $1,800/oz and consider a 1% royalty on this project, with the uncertainty intervals described in (25). Performing the requisite calculations on the α-cuts of the input IT2 MFs as described in Section 3.2 for the IT2 MF of the FMV of the royalty, we obtain the result shown in FIG. 6.

The centroid interval of the overall IT2 MF of the royalty is calculated analytically as [$14,675, 432 $16,664,031] and is illustrated in the figure. This interval represents a reasonable “negotiation range” for the royalty, given the uncertainty and imprecision in all the inputs, but note that the FMV IT2 MF extends over a much larger support range of about [$10,000,000, $23,000,000], indicative of the full imprecision in our knowledge of the input parameters. The center of the centroid interval at $15,669,732 represents the nominal scalar FMV of the royalty.

We can perform a similar averaging process over a LoM probability distribution to obtain the IT2 MF of the average FMV of the royalty. Assume the LoM distribution shown in (26):

$${P}_{L o M} = [ \begin{matrix}0 & 0 & 0 & 0 & 0 & 0 & 0 & 0.2 & 0.4 & 0.4\end{matrix} ] . \qquad ( 26 )$$

The corresponding IT2 MF for the FMV averaged over this distribution is shown in FIG. 7. We observe that the entire IT2 MF has shifted to the left, i.e., to lower values of the FMV, reflecting the likelihood of a shorter LoM and the correspondingly lower expected value of the royalty. The centroid of this IT2 MF is the interval [$14,163,358 $16,010,479] as shown in the figure, and the center of this centroid interval is $15,086,919.

### 4.2 Example Calculations for Options on Royalties

As presented in Section 4.1, the FMV of a royalty is described in terms of an IT2 MF, which accounts for the uncertainty and imprecision in the parameter values involved in its calculation. This IT2 MF is itself a major generalization of the scalar value for Sᵢ that is used in the Black-Scholes formula in (14) and (15). We shall further posit that the volatility σ and the risk-free interest rate r should be modeled as IT2 MFs to account for their imprecisely known values going forward.

To our knowledge, this is a novel method of accounting for the imprecise values of σ and r in any existing application of the Black-Scholes formula. Traditional approaches to generalizing the value of σ model it as a random process, but there are no closed-form solutions for this approach, so it requires Monte Carlo simulations to arrive at an approximate value of the resulting premium c(Sₜ,T), even in the case of a scalar value for Sₜ. The traditional approach to representing the value of r in (14) and (15) is to assume that it is a scalar constant over the life of the option, when in fact the history of interest rates set by central banks is anything but constant.

As previously described in Section 3.2, computations involving IT2 MFs are performed on the α-cuts of these MFs. For nonlinear formulas such as those in equations (14) and (15) we generally must use numerical algorithms to find the minima and maxima of each α-cut of the resultant output value, given the respective α-cuts of the internal parameters having IT2 MFs (in this case, the α-cuts of Sₜ, σ and r). Since these types of numerical algorithms are very mature, this would not represent any difficulty in our method. However, as we show below, we can analytically determine these maxima and minima in the case of the Black-Scholes model.

The partial derivatives of c(Sₜ,T) in (14) with respect to Sₜ, σ and r go by the names “delta”, “vega” and “rho”, respectively in the options trading industry, where they are used by traders to measure their exposure to movements in the price, volatility and interest rate respectively of the underlying security. For call options, these partial derivatives are given respectively by:

$$Δ = \frac{\partial c}{\partial {S}_{t}} = N ( {d}_{1} ) , \qquad ( 27 )$$

$$v = \frac{\partial c}{\partial σ} = {S}_{t} {N}^{′} ( {d}_{1} ) \sqrt{T - t} = \frac{1}{\sqrt{2 π}} {S}_{t} {e}^{- \frac{{d}_{1}^{2}}{2}} \sqrt{T - t} , \qquad ( 28 )$$

$$ρ = \frac{\partial c}{\partial r} = K ( T - t ) {e}^{- r ( T - t )} N ( {d}_{2} ) , \qquad ( 29 )$$

where N(•) is the standard normal cumulative probability distribution function. Now N(•) is always positive for any value of its argument, and thus Δ in (27) is always positive. As a result, the premium c(Sₜ,T) of a call option increases monotonically with Sₜ. Similarly, we observe that each of the terms in the respective products on the right sides of (28) and (29) are positive, therefore c (Sₜ,T) increases monotonically with σ and r as well.

Together, these facts imply the following key observation:

When Sₜ, σ and r have interval ranges of (positive) values, the minimum of c(Sₜ,T) in (14) occurs at the minimum values of the Sₜ, σ and r intervals and the maximum of c(Sₜ,T) occurs at the maximum values of the Sₜ, σ and r intervals, respectively, for all feasible values of the remaining parameters K and T in the Black-Scholes formula.

This observation enables us to calculate analytically, using the Black-Scholes formula equations in (14) and (15), the endpoints of each α-cut of an IT2 MF for c(Sₜ,T) when Sₜ, σ and r are represented by IT2 MFs, which in turn implies an extremely rapid computation of the full IT2 MF for c(Sₜ,T), compared to the alternative of Monte Carlo simulations.

To wit, if an α-cut of S, has the interval range of [sₗ, sᵣ], the corresponding α-cut of σ has the interval range [σₗ, σᵣ] and the corresponding α-cut of r has the interval range [rₗ, rᵣ] (the l and r subscripts refer to the left and right interval endpoints), then the corresponding α-cut of c(Sₜ,T) is the interval:

$$[ c ( {S}_{ℓ} , T , K , {σ}_{ℓ} , {r}_{ℓ} , t ) , c ( {S}_{r} , T , K , {σ}_{r} , {r}_{r} , t ) ] . \qquad ( 30 )$$

Using the Black-Scholes formula evaluation for each α-cut of the IT2 MF of c(Sₜ,T) enables us quickly to calculate the full MF.

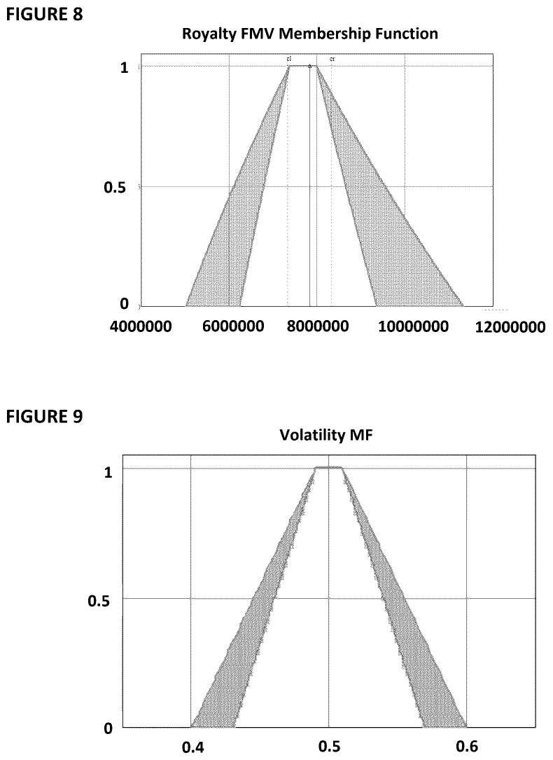

In the following, we illustrate these calculations using the previous royalty example, where the buyer of a gold project grants a 1% royalty to the seller but retains an option to buy back one-half of the royalty (i.e., a 0.5% royalty) within the next 5 years for an agreed strike price. Note that the IT2 MF of the FMV of a 0.5% royalty is simply the MF of FIG. 6 (i.e., that of a 1% royalty), with the x axis scaled by one half. This MF is shown in FIG. 8.

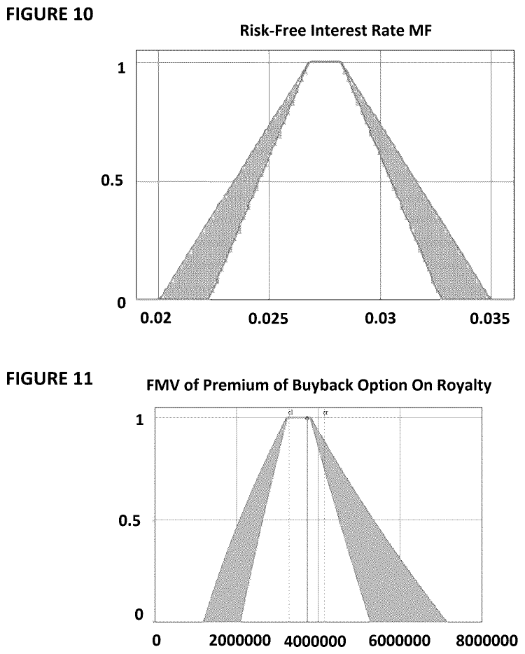

Assume a risk-free interest rate support interval of 2% to 3.5%, and a volatility support interval of 40% to 60%, both of which can be arbitrarily specified as desired. Using the method of Section 3.1 to construct the corresponding IT2 MFs for volatility and risk-free interest rates, where the support intervals of the LMFs is 70% of the UMF support interval, and the width of the unity values of the UMFs and LMFs is 10% of the UMF support interval, we obtain the volatility and risk-free interest rate IT2 MFs shown in FIGS. 9 and 10, respectively.

Further assume that the strike price for the option is the scalar value resulting from the royalty FMV MF in FIG. 8, which is $7,834,866, so the option can be considered approximately “at-the-money” when granted.

The first case we consider is the premium value for the call option when it is initially granted, i.e., at inception of the option, so that if the option is exercised immediately, royalty payments begin with the first year and continue for a full 10-year LoM.

Using the Black-Scholes formula (14) in conjunction with (30) to calculate the α-cuts of the call option premium under uncertainty and imprecision in its parameters, we show in FIG. 11 the resulting MF of the FMV of the option premium with these inputs. The centroid interval for this MF ranges from $3.29 million to $4.15 million, with a nominal scalar value of $3.72 million.

Note that the FMV of the premium for the option represents almost one-half of the strike price for the option, yet this premium value is frequently ignored when granting such a buyback option in most transactions.

In other words, the buyer of the project receives essentially a free option, whose premium value is nearly ½ of the scalar FMV of the 0.5% buyback royalty, when the strike price is equal to the scalar FMV of this royalty!

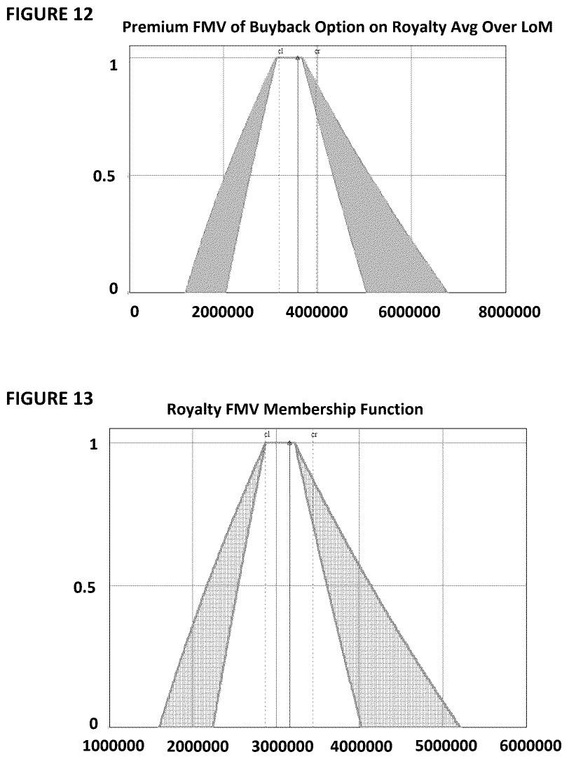

FIG. 12 shows the FMV of the option premium at inception when averaged over the LoM distribution shown in (26), with the strike price of the option set to the scalar FMV of the royalty, which is equal to $7.54 million. For this case, the interval range for the premium is $3.2 million to $4 million, with a scalar value of $3.6 million, which again amounts to almost one-half of the corresponding values for the FMV of the royalty itself.

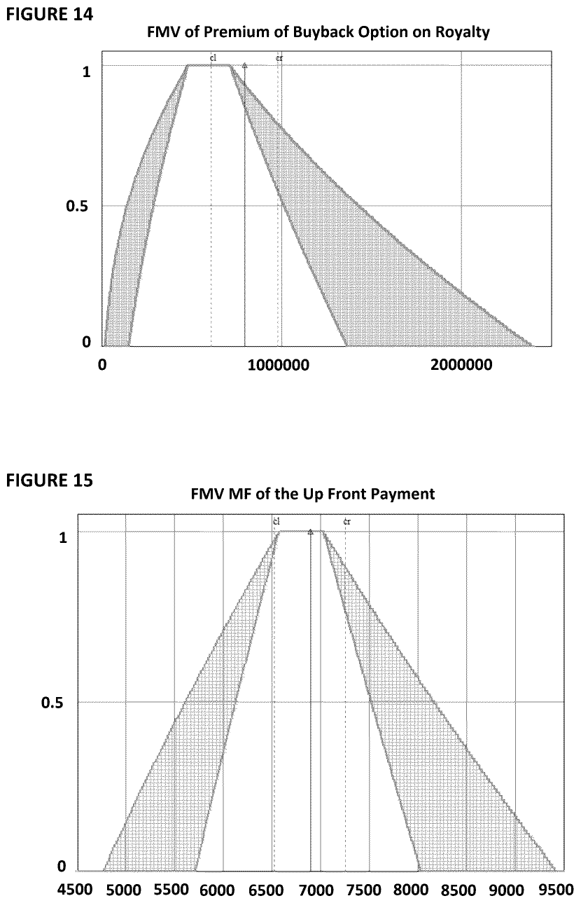

On the other hand, suppose the exercise of the buyback option is delayed to the beginning of the final year prior to its expiration at 5 years, so that n0=5 and royalty payments are made over the remaining 6-year LoM. FIG. 13 shows the MF of the FMV of the royalty payments beginning in year 5 and FIG. 14 shows the corresponding MF for the FMV of the option premium at the beginning of this final year. Note that the royalty FMV interval has declined to $2.87 million to $3.44 million, with a scalar value of $3.16 million, because of the shorter remaining period of royalty payments. The FMV interval for the option premium is now $609 thousand to $981 thousand, with a scalar value of $795,275. Also note the skewed distribution of FMV for the option at one year to expiration.

From this, we conclude that it behooves the holder of the buyback option in this example either to exercise the option immediately, in order to take advantage of the full stream of royalty payments on which he has the option, or else immediately to sell the option to another party while the premium value is at its maximum, which sacrifices any upside provided by the royalty but provides significant income from the premium value.

For sellers of a project who contemplate granting a buyback option to the buyer, the seller should recognize that the premium value of this option may be quite substantial and should be incorporated into the terms of their transaction either explicitly or implicitly, else they are providing an essentially free option.

Of course, these calculations and their corresponding inferences will vary with each property and with the terms of any royalty buyback option(s) involved in a transaction, all of which can be incorporated into our method. However, given the significant potential premium values associated with such options, it behooves all parties to be aware of their financial implications.

### 4.3 Example Calculations for Streaming Contracts

As an example of the application of our method to streaming contracts, let us assume the UMF support interval ranges shown in (31) for the input parameters in (18) for years 1 through 13. Here, the Pᵢ intervals are generated from the hazard rate intervals using (1). We use these interval ranges in conjunction with the UMF and LMF generation method described in Section 3.1 to generate the corresponding IT2 MFs for Pᵢ, aᵢ and dᵢ as done in our example for royalties.

Assume that: 1) the stream payments begin in year 2 and continue through year 13; 2) the spot price for the stream commodity is $1,800/unit and 3) there is no discounted payment for the stream (i.e., δ=0). Performing the requisite calculations of the IT2 MF for the FMV of the UFP using (18), we obtain the result in FIG. 15.

$$λ = [ \begin{matrix}0.06 & 0.08 \\ 0.055 & 0.075 \\ 0.06 & 0.07 \\ 0.05 & 0.06 \\ 0.03 & 0.04 \\ 0.03 & 0.04 \\ 0.02 & 0.03 \\ 0.02 & 0.03 \\ 0.01 & 0.02 \\ 0.01 & 0.02 \\ 0.01 & 0.02 \\ 0.01 & 0.02 \\ 0.01 & 0.02\end{matrix} ] , P = [ \begin{matrix}0.92 & 0.94 \\ 0.851 & 0.888 \\ 0.791 & 0.835 \\ 0.744 & 0.793 \\ 0.714 & 0.769 \\ 0.686 & 0.746 \\ 0.665 & 0.731 \\ 0.645 & 0717 \\ 0.632 & 0.717 \\ 0.62 & 0.703 \\ 0.607 & 0.696 \\ 0.595 & 0.689 \\ 0.583 & 0.682\end{matrix} ] , a = [ \begin{matrix}0.97 & 1.03 \\ 0 \text{.941} & 1.061 \\ 0.913 & 1.093 \\ 0.885 & 1.126 \\ 0.859 & 1.159 \\ 0.833 & 1.194 \\ 0.808 & 1.23 \\ 0.784 & 1.267 \\ 0.76 & 1.305 \\ 0.737 & 1.344 \\ 0.715 & 1.384 \\ 0.694 & 1.426 \\ 0.673 & 1.469\end{matrix} ] , \qquad ( 31 )$$

$$d = [ \begin{matrix}0.86 & 0.9 \\ 0.74 & 0.81 \\ 0.636 & 0.729 \\ 0.547 & 0.656 \\ 0.47 & 0.59 \\ 0.405 & 0 \text{.531} \\ 0.348 & 0.478 \\ 0.299 & 0.43 \\ 0.257 & 0.387 \\ 0 \text{.221} & 0.349 \\ 0.19 & 0.314 \\ 0.164 & 0.282 \\ 0.141 & 0.254\end{matrix} ]$$

The centroid interval of the IT2 MF is calculated analytically as [$6,526, $7,257], with a scalar midpoint of $6,892. This interval represents a reasonable “negotiation range” for the upfront payment for the stream, given the uncertainty and imprecision in all the inputs, but note that the FMV IT2 MF extends over a much larger range of about [$4, 750, $9,400], indicative of the full imprecision in our knowledge of the input parameters. The center of the centroid interval at $6,892 represents the nominal scalar FMV of the per unit UFP of the stream.

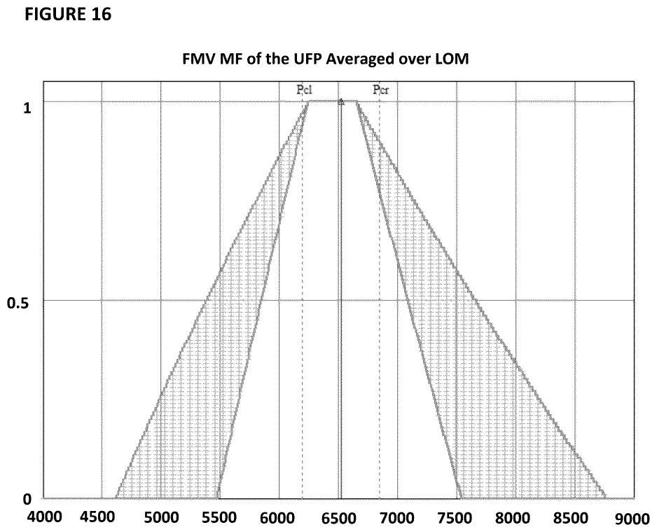

We can perform a similar averaging process over the LoM probability distribution as shown in (19), to obtain the IT2 MF of the average FMV shown in FIG. 16. As in FIG. 7, the entire IT2 MF has shifted to the left, i.e., to lower values of the FMV. This reflects the likelihood of a shorter LoM, from the probability distribution shown in (19), and the correspondingly lower upfront payment for each unit of the commodity. The centroid of this IT2 MF is the interval [$6,199, $6, 850], as shown in the figure, and the center of this centroid interval is $6,525.

We can use the centroid intervals calculated for either of the above cases in (24) to calculate the “negotiation range” of the number of units of the stream payment required to raise a given amount of upfront payments. This is done via the interval arithmetic division operation. Thus, for the fixed number of stream payments, where the corresponding centroid interval is [$6,526, $7,257] we have:

$$stream payments = \frac{Total upfront payments}{[ \begin{matrix}6526 & 7257\end{matrix} ]} = Total upfront payments * [ \begin{matrix}0.000138 & 0.000153\end{matrix} ] \qquad ( 32 )$$

Thus, for example, the “negotiation range” of annual stream payments needed to raise $10 million in capital would be between 1380 and 1530 units of the commodity.

In the case of the LoM streaming contract, and using the centroid interval [$6,199, $6,850] of the previous example, the corresponding calculation for the number of stream payments yields:

$$stream payments = \frac{Total upfront payments}{[ 6199 , 6850 ]} = Total upfront payments * [ 0.000146 , 0.0001613 ] \qquad ( 33 )$$

Thus, to raise $10 million in capital for this LoM stream case, the “negotiation range” of stream payments would be between 1,460 and 1,613 units of the commodity delivered each year.

### 5.0 Applications

The most immediate application of the methods described in this invention is to facilitate negotiations between a buyer and seller of royalties, options on royalties and/or streaming contracts. Even in cases where there is a wide range of values in the centroid interval, its upper and lower values act as reasonable boundaries on the negotiation price and provide leverage to a party whose negotiating position might otherwise be weak. This helps to negate overreaching by the stronger party and to support fair resolutions.

Of particular importance is the fact that inefficient pricing of options on royalties is not merely a matter of unequal bargaining power or information asymmetries but seems to be the result of the inability of both buyers and sellers to address the pricing issue in a rigorous manner. Our method solves that problem directly and separates it from discrete elements of the broader purchase and sale negotiations, lending greater efficiency to the latter.

Beyond two-party negotiations, our methods will be of substantial value to unrelated parties not directly involved in purchase and sale negotiations on these instruments. For example, hedge funds and other arbitrageurs can use our methods to identify arguably overvalued or undervalued option agreements held by market participants. In those circumstances, the arbitrageurs can, for example, short the stock of holders of overvalued options or purchase the stock of holders of undervalued options in anticipation of a convergence of perceived market value and real value over time.

Our approach can also be used by accountants, appraisers, and bankers in advising and financing the buyers and sellers of royalties, options on royalties and streaming contracts. Finally, investment bankers can use this valuation technique in assessing merger or acquisition prospects for clients.

Over time, improved valuation methods have been shown to reduce transaction costs, improve liquidity, and facilitate price discovery in markets.

In yet another alternative embodiment, the present invention can be used as the basis of an automated computer system comprised of a computer, a database (or link to a data set) and a software package designed to (1) compute scalar values for all input factors and generalize this result to the case where all inputs whose values are imprecisely known are represented using IT2 MFs and (2) compute the production quantities, the survival probabilities, the appreciation/depreciation factors and discount factors in an analytical derivation of FMVs of royalties, options on royalties and streaming contract. With this information, the system can utilize financial instruments involving streams of payments in many commodity markets or estimate the fair market value (FMV) in transaction negotiations, proper accounting, hedging, arbitrage, and/or trading. In another alternative embodiment, the system is located on a server and accessed remotely over a network or through cloud computing, including, but not limited to, wired, wireless, and hybrid networks.

### 6.0 Conclusion

This invention describes a method for the analytical derivation of the FMVs of royalties, options on royalties, streaming contracts and related financial instruments, taking account of the uncertain and imprecise knowledge of all input factors, including the production quantities prᵢ, the survival probabilities Pᵢ, the appreciation/depreciation factors aᵢ and the discount factors dᵢ, all for i=n0, . . . , n, along with the spot price pₛₚₒₜ and the discounted purchase price δ in the case of streaming contracts.

We first derive the FMVs of these instruments using scalar values for all inputs, which presumes precise knowledge of these inputs. We then generalize this result to the case where all inputs whose values are imprecisely known are represented using IT2 MFs, which capture both the primary and secondary imprecision in our knowledge inherent to these inputs. We illustrate these calculations using a conveniently synthesized set of IT2 MFs for these various inputs, but the method is applicable to arbitrary choices for synthesizing these inputs.

The calculations involved are straightforward and are vastly less numerically intensive than what would be required for Monte Carlo simulations of the model uncertainties.

Features of the system and method according to the invention will be further illustrated by various embodiments which are given for information purposes only and are not intended to limit the invention to any extent, while making reference to the annexed drawings.

Although the present invention has been described with reference to specific embodiments, workers skilled in the art will recognize that many variations may be made therefrom. Thus, a system and method for analytical derivation of FMVs of royalties, options on royalties or a streaming contract is disclosed in the embodiments herein. Accordingly, other objects and advantages of the invention will be apparent to those skilled in the art from the detailed description together with the claims.

### REFERENCES

[1] Stream financing: a primer. Retrieved from https://www.stikeman.com/en-ca/kh/canadian-mining-law/stream-financing-a-primer.
[2] Streaming and royalties in mining: Let the music play on (2021). Retrieved from https://www.mckinsey.com/industries/metals-and-mining/our-insights/streaming-and-royalties-in-mining-let-the-music-play-on.
[3] Mendel, J. (2001) Uncertain Rule-Based Fuzzy Logic Systems. Upper Saddle River, NJ: Prentice-Hall.
[4] Mendel, J. and D. Wu (2010) Perceptual Computing. Hoboken, NJ: John Wiley & Sons, Inc.
[5] Fokker-Planck equation. Retrieved from https://en.wikipedia.org/wiki/Fokker-Planck_equation.
[6] Black-Scholes model. Retrieved from https://en.wikipedia.org/wiki/Black-Scholes_model.
[7] Bouchaud, J-P and M. Potters (2000) Theory of Financial Risks. Cambridge, UK: Cambridge University Press.
[8] Kenton, W. Certainty Equivalent Definition. Retrieved from Investopedia: https://www.investopedia.com/terms/c/certaintyequivalent.asp.
[9] Hao, M. and J. M. Mendel (2016) “Encoding words into normal interval type-2 fuzzy sets: HM approach,” IEEE Trans. On Fuzzy Systems, vol. 24, no. 4, pp. 865-879.

1. A method for estimating a FMV of contingent payment streams for a financial instrument comprising:
a. deriving scalar values for the FMV using precise knowledge inputs;
b. generalizing imprecisely known inputs using IT2 MFs;
c. calculating a set of IT2 MFs for these various inputs using interval data provided by SMEs; and
d. using the IT2 MFs calculated in c. to calculate the corresponding IT2 MF of the FMV,
where this FMV IT2 MF accounts for the uncertainties and imprecise knowledge of all the factors involved in the contingent payment stream.

2. The method according to claim 1 wherein the precise knowledge input is a fundamental parameter based on knowledge of one or more input parameters.

3. The method according to claim 1 wherein the IT2 MFs capture both primary and secondary imprecision inherent to the inputs.

4. The method according to claim 1 wherein higher-order fuzzy membership functions, e.g., general type-2 membership functions and their corresponding computations are used in steps b., c. and d.

5. The method according to claim 3 wherein the fundamental input parameter value incorporates multiple SME interval estimates.

6. The method according to claim 1 wherein the calculations are based on IT2 MFs that combine the primary and secondary uncertainty of each parameter value.

7. The method according to claim 1 wherein the interval type-2 fuzzy membership functions are reduced to a corresponding interval range whose midpoint provides a notional scalar value by type-reduction.

8. The method according to claim 7 wherein the type-reduction of the FMV IT2 MF to an interval range is used in transaction negotiations to arrive at a final valuation for the financial instrument.

9. The method according to claim 7 wherein the type-reduction of the FMV IT2 MF to an interval range is used for proper accounting, hedging, arbitrage, or trading.

10. The method according to claim 1 wherein the financial instrument is a royalty.

11. The method according to claim 10 wherein the royalty is ascribed a notional value

12. The method according to claim 10 wherein the royalty payments have a non-zero probability of halting due to production failure.

13. The method according to claim 10 wherein the royalty payments are based on the life of the mine in the mining industry, the life of a well in the oil or gas industry or similar duration estimates for a commodity project.

14. The method according to claim 1 wherein the financial instruments are options on royalties.

15. The method according to claim 14 wherein the option on royalties is ascribed a notional value.

16. The method according to claim 14 wherein the option on royalties includes a royalty buyback option.

17. The method according to claim 14 wherein the option on royalties further includes a Black-Scholes model for evaluating an option premium.

18. The method according to claim 14 wherein the option on royalties further includes extensions of the Black-Scholes model, for example the binomial pricing model.

19. The method according to claim 1 wherein the financial instrument is a streaming contract.

20. The method according to claim 19 wherein the streaming contract has a discounted price.

21. The method according to claim 19 wherein the streaming contract has no discounted price

22. The method according to claim 19 wherein the streaming contract is specified over a defined lifetime or for a variable period.

23. The method according to claim 19 where the streaming contract provides a specific upfront payment per unit used as a negotiated value.

24. A computer for assessing a FMV payment stream for a financial instrument comprising:
a. a processor;
b. a display device;
c. a storage device; and
d. a memory, the memory comprising software instructions, the software instructions comprising instructions for:
i. estimating the IT2 MF of a FMV for a contingent payment stream for a financial instrument of claim 1;
ii. type-reducing the IT2 MF to a negotiation interval;
iii. calculating the midpoint of the negotiation interval as a notional scalar FMV; and
iv. displaying these results on the display device to show the expected FMV IT2 MF and its derived components in ii. and iii.

25. The computer in claim 24 where the computer displays the FMV for a contingent payment stream.

26. The computer in claim 24 where the computer display for the financial instrument is selected from the group consisting of royalties, options on royalties, streaming contracts, and combinations thereof.

27. A server for estimating the FMV payment stream for a financial instrument comprising:
a. a processor;
b. a network to which the processor is connected;
c. a storage device connected to the processor; and
d. a memory, the memory comprising software instructions, the software instructions comprising instructions for:
i. receiving over the network information related to the calculation of the FMV of a contingent payment stream for a financial instrument of claim 1; and
ii. returning the results over the network information related to the calculation of the FMV of a contingent payment stream of claim 1.

28. The server for estimating the FMV payment stream in claim 27 wherein the network is selected from the group consisting of the Internet, intranet, local area networks (LANS), wide area networks (WANS), and a wireless network.

29. The server for estimating the FMV payment stream in claim 27 wherein the network comprises a plurality of interconnected networks.

30. The server for estimating the FMV payment stream in claim 27 where the financial instrument is selected from the group consisting of royalties, options on royalties, streaming contracts, and combinations thereof.
